(19) United States
(12) Patent Application Publication
(10) Pub. No.: US 2005/0096997 A1
(43) Pub. Date: May 5, 2005

(54) Targeting shoppers in an online shopping environment

(76) Inventors: Vivek Jain, New Delhi (IN); Ravi Kothari, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/699,173

(22) Filed: Oct. 31, 2003

(51) Int. Cl. G06F 17/60

(52) U.S. Cl. 705/26; 705/27

(57) ABSTRACT

Within an online shopping environment, a hosting server supports shoppers and merchants from whom the shoppers purchase goods or services. The hosting server enables an individual user to shop or browse the merchant sites and also enables a group of users to coordinate their shopping or browsing activities. A set of profiling tools build separate profiles based on individual and group shopper activity, as well as the interaction of an individual shopper with one or more groups of shoppers. A targeting tool uses the shopper profiles and information regarding previous promotions (if any) from a promotions library to make recommendations to individual shoppers and shopper groups based also on parameters specified by the merchant/s. The recommendations are directed to shoppers, in accordance with algorithms stored in a repository.

### FIELD OF THE INVENTION

The present invention relates to online (electronic) shopping environments, for example Business-to-Consumer (B2C) e-commerce. It relates particularly to shopping situations where shoppers participate both individually and as members of a group.

### BACKGROUND

In this specification, any reference to business servers, merchants, and vendors are to be treated as synonyms. Similarly, references to clients, consumers, customers, and shoppers are to be treated as synonyms.

Electronic commerce, and particularly that in the B2C form, is becoming ever more prevalent. It allows shoppers the freedom to purchase goods or services from anywhere in the world with ease. For merchants, there is a need to compete with other merchants offering similar goods or services, and thus marketing strategies must be employed to remain competitive. One aspect of this is to be cognisant of customer behavior.

Consumer behavior is a social process followed by individuals, groups, or organizations, to select, secure, use, and dispose of products, services, experiences, or ideas to satisfy needs. Behavior occurs either for the individual, or in the context of a group (for example, friends influence what kinds of clothes a person wears) or an organization (people make decisions as to which products a firm should use). A person may buy a product based on the influence of neighbors, relatives, friends, colleagues, acquaintances, expert opinion, legal opinion, group norms of behavior, social norms, and so on.

U.S. Patent Application No. 20020083134 (Bauer et al.), published on Jun. 27, 2002 describes a collaborative system, in which a session leader can be selected by consent, or by external factors such as being a knowledge expert. A client program communicates with other client programs in a server defined cell, including group chatting, sending private instant messages or sharing files. A cell can be a site or group of sites, with each of the WebPages, top level-domains acting as cells. A client program communicates with client programs in other sessions and can dynamically enter, leave, lead, follow a session, communicate with other clients or become aware of other sessions. A user can, at times, prevent others from following, chatting or collaboratively browsing by blocking a specific user or all other users.

U.S. Patent Application No. 20010037365 (Montague et al), published on Nov. 1, 2001, describes a method of linking a group of client stations such that the operator of one or more client stations can guide or dictate what is viewed on other client stations. A first client sends a URL resource identifier to a server station, which sends the URL resource identifier to the authorized users of a group. Group users are then directed to the URL resource submitted by the first user. The system allows a user of the group to annotate the URL resource and the annotation is displayed on each of the client stations. A first computer marks over a discrete location on the arbitrary web content, and—a corresponding mark appears on the client stations through synchronizing pointers.

Bauer et al. and Montague et al thus describe collaborative systems, that enable users to share their resources, be aware of other users, enable them to invite them to join their groups, and also shop individually and together as a group. But they are directed only to the behavior of the shopper, and do not suggest any benefit for the merchant in an online shopping environment.

U.S. Patent Application No. 20020016786 (Pitkow et al.), published on Feb. 7, 2002 (which was officially published with incorrect drawings) describes a search and recommendation system that employs the preferences and profiles of individual users and groups within a community of users, as well as information derived from categorically organized content pointers, to augment Internet searches, re-rank search results, and provide recommendations for objects based on an initial subject-matter query. The search and recommendation systems taught by Pitkow et al operate in the context of a content pointer manager, which stores individual users' content pointers (some of which may be published or shared for group use) on a centralized content pointer database connected to the Internet. The shared content pointer manager is implemented as a distributed program, portions of which operate on users' terminals, and other portions of which operate on the centralized content pointer database. A user's content pointers are organized in accordance with a local topical categorical hierarchy. The hierarchical organization is used to define a relevance context within which returned objects are evaluated and ordered. Content pointers are only of limited usefulness in targeting shoppers.

There remains a need to consider the online shopping environment from the point of view of the merchant in terms of the individual and collective behavior of the shoppers.

### SUMMARY

For shoppers participating in online shopping, data regarding the choices of individual shoppers, when shopping individually, is collected, and an individual shopping behaviour measure is determined. Data regarding the choices of individual shopping when participating in group shopping is also collected. A group shopping behaviour measure is determined from this data. A shopper-group interaction measure is determined from both the individual shopping data and the group shopping data. Targeted information is determined on the basis of at least the shopper-group interaction measure. It can, additionally, be determined on the basis of the individual shopping behaviour measure and the group shopping measure behaviour. The targeted information is sent to one or more targeted shoppers.

The shopper-group interaction measure is determined on the basis of one or more of a set of indices. The indices relate to shopper affinity, leadership, conformity and assertiveness. Shopper affinity can be determined on the basis of the number of times a shopper has voted with other members of the group, the number of times a shopper's proposal has been voted for by other members of the group, the number of times a shopper has been invited by or issued an invitation to other members of the group, and the number of shopping groups that a shopper is commonly a member of with other shoppers. The leadership index is determined from a shopper's purchase recommendations and the number of times other shoppers in the group have followed such recommendations. The conformity index depends upon a shopper's voting record regarding purchase proposals with reference to a majority or lead shopper. The assertiveness index is similar, but relating to disagreement with a majority or a lead shopper.

The targeted information is determined on the basis of one or more of a rule specified by a merchant and an adaptive algorithmic rule. The adaptive rule learns from one or more of the indices, and potentially also from the group shopping measure. The group shopping measure can be determined on the basis of the degree of assimilation of members of a group. For an assimilated group, this leads to targeting information to a group as a whole. For a group showing lack of assimilation, this leads to targeting information to individual shoppers.

### DESCRIPTION OF DRAWINGS

FIG. 1 is a schematic block diagram of a B2C electronic shopping infrastructure.

FIG. 2 is a schematic block diagram of the functions performed by the hosting server.

FIG. 3 is a flow diagram of shopper interaction with the collaborative shopping system.

FIG. 4 is a flow diagram of the process of targeting shoppers.

FIG. 5 is a schematic representation of a computer system suitable for performing the is techniques described with reference to FIGS. 1 to 4.

### DETAILED DESCRIPTION

Infrastructure

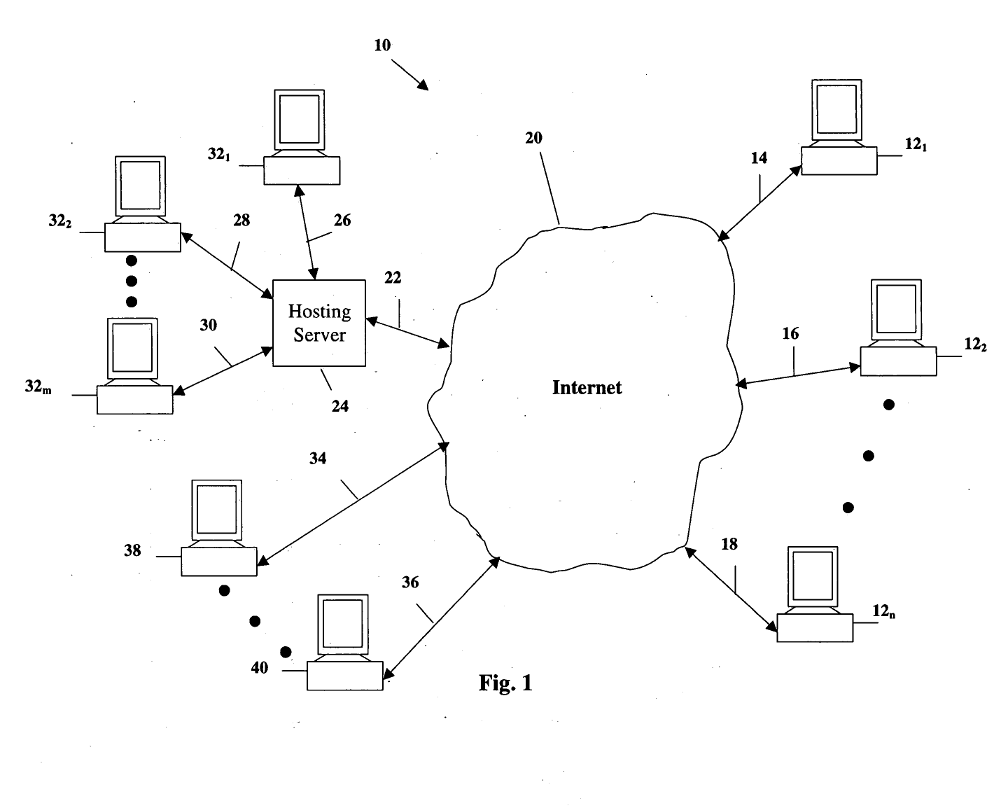

FIG. 1 shows a B2C electronic shopping infrastructure 10. A number of shoppers 12ₙ are connected by respective computer terminals via communication links 14, 16, 18 to a public or private e-commerce network 20, most usually the Internet.

A communications link 22 connects a hosting server 24 with the Internet 20. The hosting server 24 acts as a gateway and coordinator for a plurality of merchants. Communication links 26, 28, 30 connect the hosting server 24 with the merchants servers 32ₘ. In this arrangement, the m number of merchants are collaborating in offering goods or services to the shoppers 12ₙ over the Internet 20. It is equally possible for the invention to be practiced in a form where only a single merchant implements the functionality of the hosting server.

Further communication links 34, 36 connect other merchants 38, 40 to the Internet 20.

These other merchants 38, 40 are competing with the merchants 32ₘ practising the invention. All of the merchants 32ₘ, 38, 40 are configured to allow group shopping by members of the group of customers 12ₙ.

The arrangement of FIG. 1 is somewhat simplified for the purpose of ease of description. In a real-world application, there may be hundreds or thousands of shoppers acting collaboratively, and tens or hundreds of merchants.

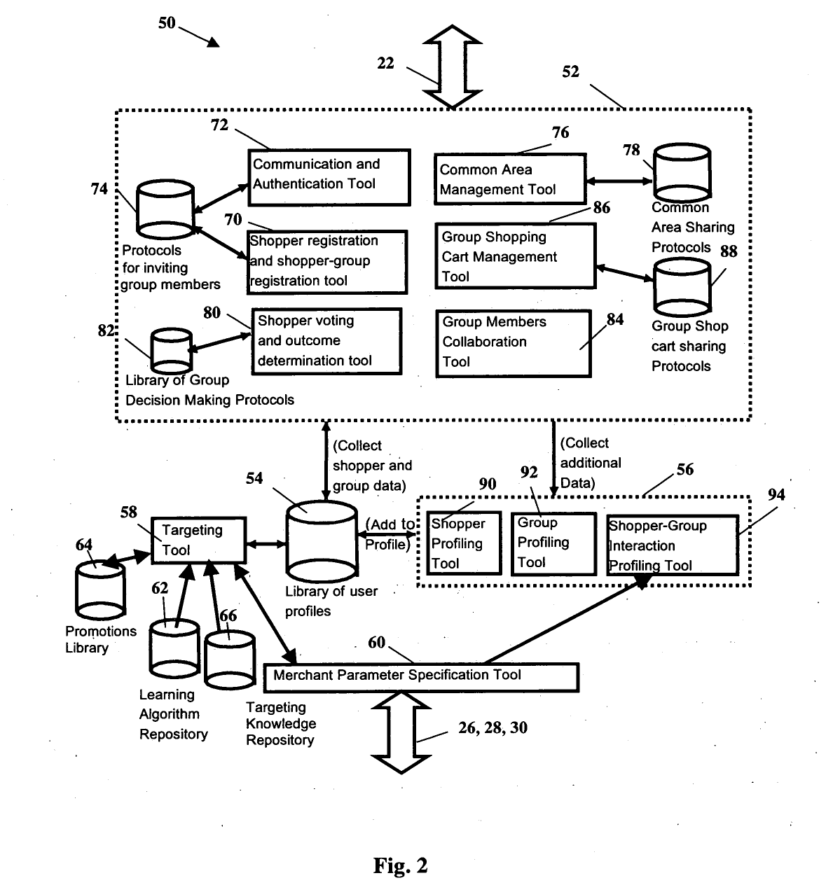

FIG. 2 is a schematic block diagram of a collaborative shopping system 50 residing on the hosting server 24. The system 50 has the main components of a user/shopper interface 52, a library of user profiles 54, a collection of profiling tools 56, a targeting tool 58, a merchant parameter specification tool 60, a learning algorithms repository 62, a targeting knowledge repository 66, and a promotions library 64. The link 22 to the Internet 20 is via the interface 52. The links 26, 28, 30 to the respective merchants 32ₘ is via the merchant parameter specification tool 60. The internal links between the elements of the system 50 will be described in what follows.

Overview

The system 50 enables an individual user to shop or browse the merchant sites 32ₘ and also enables a group of users to coordinate their shopping or browsing activities. The profiling tools 56 build separate profiles based on individual and group shopper activity, as well as the interaction of an individual shopper with one or more groups of shoppers. All such profiles are stored in the library 54. The targeting tool 58 uses the shopper profiles from this library 54, and information regarding previous promotions (if any) from the promotions library 64 to make recommendations based also on the parameters specified by the merchant/s through the merchant parameter specification tool 60. The recommendations are directed to shoppers, in accordance with algorithms stored in the repository 62, and any acquired knowledge from the targeting knowledge repository 66.

Shopper Registration

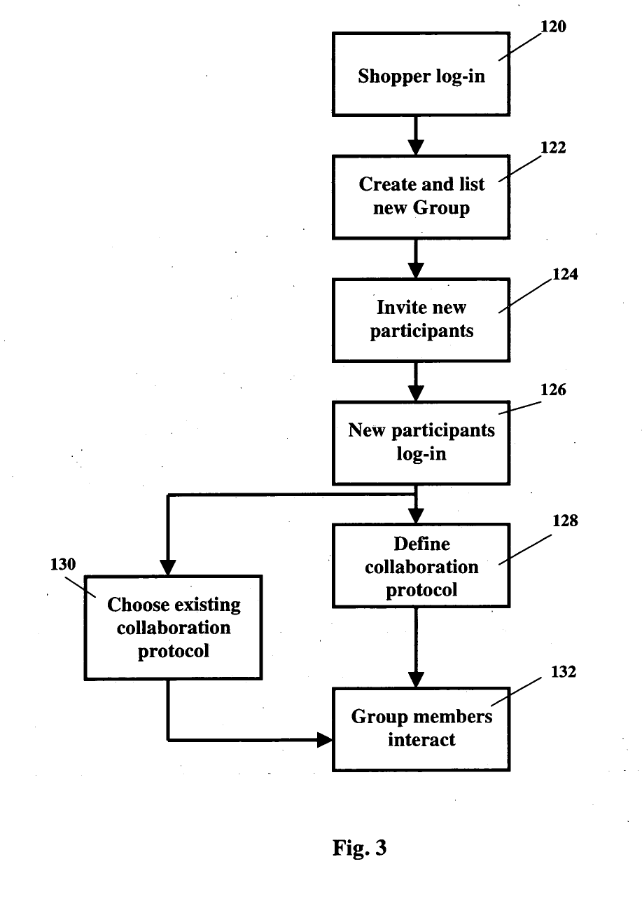

Referring now to the flow diagram of FIG. 3, the process of shopper registration (as an individual and member of a group) will be described.

A user visits the hosting server site 24 and logs in (step 120), using the Shopper Registration and Shopper-Group Registration Tool 70 and the Communication and Authentication Tool 72.

The user creates and lists a new group, and invites new participants from broader community of shoppers (or a subset of them) (step 124), using the Shopper Registration and Shopper-Group Registration Tool 70, and Library of Protocols for Group Creation and Inviting New Members 74. The user invites one or more friends using a “chat” facility (spontaneously, or by awareness of friends' logging pattern). The user may also provide the authentication details of the friend(s) to the system 50.

The friend(s) (i.e. the invitees to the new group) visit the server (step 126), and implicitly or explicitly provide the authentication credentials, and are recognized using the Shopper Registration and Shopper-Group Registration Tool 70 and Communication and Authentication Tool 72. For example, the authentication data might be the IP address of the friend(s). A visit by the friend from that IP address implicitly authenticates the friend(s). The user and friends are “bound” together through a “common area” in their respective browser windows. Interactive tools allow the participants to share text or voice based notes, diagrams, pictures, annotations in the “common area”.

The users use one of the existing protocols available to the participants or define a new set of protocols to control their collaboration (step 128). Alternatively, a set of protocols are available that enable individuals to be invited to a collaborative session in progress (step 130).

The group members now interact (step 132) in one or more of the following ways:
A user uses the collaborative system to shop together or individually.
A user makes a proposal to the group.
A user votes on a proposal.
A user leaves the group temporarily or permanently.
A user switches to private mode, disabling other participants ability to view his/her activities or presence in the same collaborative shopping system.
A user receives the goods purchased based on fulfilment details provided by him/her.
A user sends a gift to one of the group members.
A user accepts or rejects a gift sent by another member of the group.
A user pays for the individual share of the group's purchase.
A user pays for the group's purchase.
A user may at his or her discretion disable all profiling
   Library of Protocols for Group Creation and Inviting New Members

The Library of Protocols for Group Creation and Inviting New Members 74 contains a set of protocols are available that enable individuals to be invited to a collaborative session in progress. These protocols may include:
(a) any member of the current group can invite the new member,
(b) all members of the current group must agree before a member can invite a new member,
(c) members of the group can vote out a member of the group,
(d) a new member aspiring to be part of the group should go through a process of registration which may comprise of a set of criterion that the new members should meet.

The system 50 also enables the users to define new protocols of their own, with every member having the option of voluntary joining or leaving the group, but rights to join may be restricted by the members of the group.

Communication and Authentication Tool

The Communication and Authentication Tool 72 enables the system 50 to communicate in a secure manner through Secure Socket Layer protocol or other Internet and wireless or encryption technologies. The shoppers are authenticated based on their identification and authentication information available with the system. For example, the authentication data might be the IP address. A visit by a shopper from that IP address implicitly authenticates the shopper. The authentication tool 72 ensures that each shopper conforms to the system protocol for registration with the system and also with group membership protocols as defined in the Library of Protocols for Group Creation and Inviting New Members 74.

Common Area Management Tool and Library of Common Area Sharing Protocols

Participants are “bound” together through a “common area” in their respective browser windows. Interactive tools allow the participants to share text or voice based notes, diagrams, pictures, annotations in the “common area”. It may also include a “chat” facility. The Common Area Management Tool 76 has associated Common Area Sharing Protocols 78 that it supports. The navigation support system supports protocols for controlling the common area. For example, in an autocratic mode, the activity of the user is pushed to the “common area” of the friend(s) respective browser windows. In the democratic mode, the first activity causes a disablement of activity in the “common area” of the other participants. In another protocol, a user whose proposal is accepted (using the Shopper Voting and Outcome Determination Tool 80 and the Library of Group Decision Making Protocols 82 and is followed becomes the lead participant and the common area is tied to the activity of the lead participant.

Shopper Voting and Outcome Determination Tool

The Shopper Voting and Outcome Determination Tool 80 provides a mechanism for users to submit proposals and seek group's feedback/decision on the proposal. The tool enables members to submit their opinions about the proposal and determines the final decision based on the library of Group Decision Making Protocols 82. A navigation support system enables proposing an activity, communicating the agreement or disagreement of the activity. The system 50 allows users to propose a particular activity to the group, for example, visiting a particular page or shopping a particular product or inviting a new friend or asking someone to leave the group. The agreement or disagreement may be communicated, for example, through a menu of choices or buttons or other user interface elements. Agreement or disagreement of an individual may or may not be visible to other participants; however it is always visible to the system 50 unless the user has chosen to disable profiling.

Library of Group Decision Making Protocols

The Library of Group Decision Making Protocols 82 contains the protocols that can be used by groups to arrive at a collective decision for a proposal submitted by any member of the group or received otherwise from an external agent. For example, one of the protocols may be through a simple voting mechanism, i.e., a majority vote is required for a proposal to be accepted. Other acceptance mechanisms may exist. For example, the creator of the group may have a final say in the matter or the initiator of the current session may have the final authority to decide the outcome.

Group Member Collaboration Tool

The Group Member Collaboration Tool 84 comprises of a set of collaboration tools, for example, chat and white board sharing. Collaboration (chat messages, navigation history, transactions) can be logged, and early departures or late arrivals can review the collaboration log. The collaboration logs are available to the profiling system 56 and the library of user profiles 54.

Group Shopping Cart Management Tool and Group Shopping Cart Sharing Protocols

Purchase and fulfilment is specific to the individual participants. In addition to the individual shopping carts, the tool 86 provides a group shopping cart and a shared payment mechanism which the members can use for payment of goods purchased in common, in accordance with stored protocols 88.

Targeting Shoppers

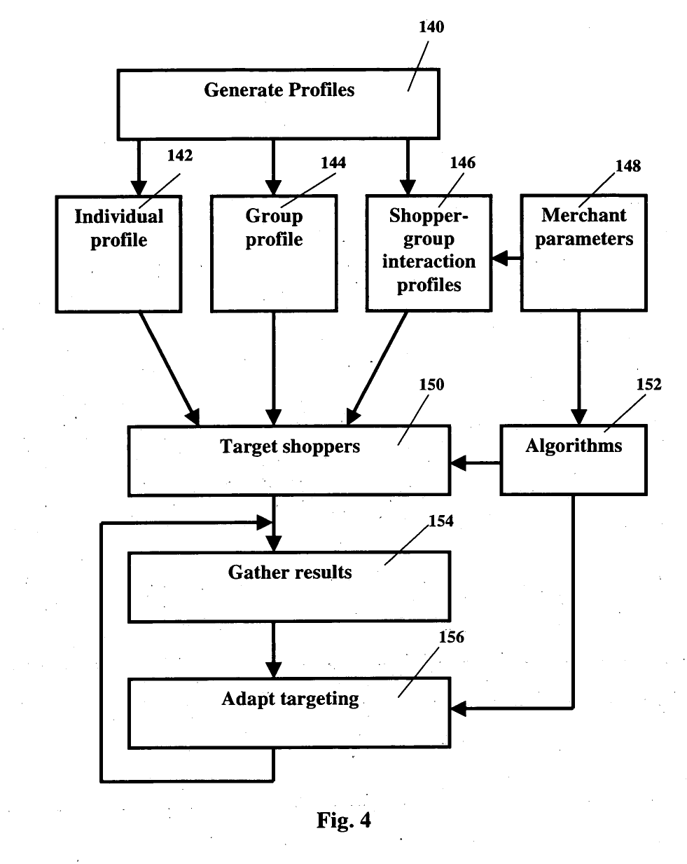

Referring now to FIG. 4, which continues on from FIG. 3, the broad steps that lead to targeting shoppers are now performed. In step 140, shopper profiles are generated, leading to a set of individual profiles 142, a set of group profiles 144, and a set of shopper-group interaction profiles 146. The composition of the shopper-group interaction profiles can be a function of chosen merchant parameters 148. Next, in step 150, shoppers are targeted, with input contributed from learned algorithms (step 152 that can also be influenced by chosen merchant parameters 148). The results of the targeting are gathered in step 154, leading to adapted targeting (step 156), which can have inputs from the learned algorithms (step 152 repeated). The adaptation of step 156 is repeating.

Library of User Profiles

The overall library of user profiles 54 comprises of three components: individual user profiles, group profiles and individuals' group profiles.

The individual user profiles comprise of information specific to an individual and pertain to demographics, income, purchase history, navigation history, and preferences.

The group profiles comprises of information specific to the group of users, having a static components which characterize the entire group (for example, “likes string instruments”) and a dynamic component that is adaptively generated based on the participants at a given point in time. As individuals enter or leave the group session, the dynamic component changes. The static component is updated periodically or can change when new members register for the group or registered members permanently leave the group.

An individual's group profile comprises of information specific to the individual as regards to his or her behavior in the group. This profile captures the change in the individual's behavior in the presence of others.

Shopper Profiling Tool

Within the profiling tools 56 is a Shopper Profiling Tool 90 that populates the individual user profiles within the library 54. The individual user profiles comprise of information specific to an individual and pertain to demographics, income, purchase history, navigation history, and preferences. The shopper profiling tool 90 captures the information through the collaboration tool 84 and records the information. The information may be preprocessed by removing system-level details or transformed using learning tools or segmentation tools to enrich the shopper's profile with relative comparison with other shopper's individual profile.

Group Profiling Tool

A group profiling tool 92 uses the collaboration logs, the past transaction and the navigation patterns for each individual and the collective, the voting for and against another member's proposal and other exchanges (text or voice based notes, diagrams, pictures, annotations) to continually build and update the group profile stored in the library 54.

The group profile contains the following information:

1. Size of the group.

2. Level of communication (activity, frequency of meeting, average number of proposals made per session, average number of users in a given session, average session length).

3. Derived information from purchase history of the collaborative purchasing sessions, for example, average amount of purchases made by the group per collaborative shopping session, average number of items purchased per session, percentage of sessions leading to a purchase, categories in which purchases were made and most frequently purchased products by the group and so on. The purchases made through the group shopping cart may also be combined by the individual's shopping cart and new measures created based on this combination.

4. 4. Preferences (favourite categories, products, pages, communication channel i.e., chat or audio or video or annotation, time of session begin, time of session end, day of the week). The preference information may be derived from the browsing records of each collaborative shopping session or from the purchase history of the group. Individual profiles in any case capture the individual's preferences. The group shopping cart and the group's browsing history is used for creating group's profile.

5. Harmony in the group: (a) continuity in the topic of discussion as the lead user changes, (b) fraction of proposals accepted, (c) the margin of acceptance and (d) number of proposals to session length. The continuity in the topic is determined by the frequency distribution of topics for each lead user and computation of the difference in the distributions of topics. Standard deviation of votes polled on a proposal, or the difference between the maximum votes and the next highest number of votes, is also a possible measure of consensus (or difference of opinion) within the group.

6. Culture of the group: For each of the group's, the culture is described by a set of indices—Group compatibility and agreement index, Youthfulness Index, or Maturity Index. The value of these indices may be deterministically computed from the behavior of the groups as described later. Otherwise, an outside agent may specify values of these indices to these groups based on observations of the group behavior and a learning tool generalizes to other groups.

a. Group Compatibility and Agreement Index: Groups can be characterized by different perspectives on the diversity of culture exist. The “melting pot” metaphor suggests that all individual participants in the group gradually assimilate after they arrive. Therefore, in the long run, there will be few differences between individuals and instead, one mainstream culture that incorporates elements from each individual will result. The “salad bowl” metaphor, in contrast, suggests that although individuals interact with each other (ie. salad) and contain some elements of the group (ie. through the dressing), each individual maintains its own significant traits (ie. each vegetable is different from the others). A time series analysis of the shopping history, other activities on the merchant's site prior to joining a group, and the behavior of the individual shoppers after joining the group, determines an index (a number between 0 and 1) whether the group is a melting pot (1) or a salad bowl (0). One measure of compatibility of the group is the average of correlation between the individual purchases and group purchases.

b. Youthfulness Index: Subculture elements can also be associated, for example, youthfulness of the group, “kiddish”, “teenage”, “adult”, “mature”, etc. An outside agent provides the scores for some of the group's interactions, based on purchase history and browsing records. A learning tool generalizes to other groups identifying the youthfulness of group's interactions.
c. Maturity Index: The groups are also characterized by the atmosphere with in the group and what drives the group influence on the individual. The groups can be divided into the informational kind (influence is based almost entirely on members' knowledge), normative (members influence what is perceived to be “right,” “proper,” “responsible,” or “cool”), or identification. The difference between the latter two categories involves the individual's motivation for compliance. In case of the normative reference group, the individual tends to comply largely for utilitarian reasons-dressing according to company standards is likely to help your career, but there is no real motivation to dress that way outside the job. In contrast, people comply with identification groups' standards for the sake of belonging—for example, a member of a religious group may wear a symbol even outside the house of worship because the religion is a part of the person's identity. An outside agent may specify values of these indices to these groups based on observations of the group behavior and a learning tool generalizes to other groups.

7. Seasonal variation or trend analysis of variables in items 1-6 above.

Example of Group Profiling

For the purposes of the example, consider the representative values tabulated below.

TABLE 1

| | Group1 | Group2 | Group3 | Group4 | Group5 | Group6 |
|---|---|---|---|---|---|---|
| Size of the group | 10 | 5 | 3 | 8 | 12 | 2 |
| Group start date | Jun-01 | Jul-01 | Feb-01 | Sep-02 | Oct-01 | Jul-03 |
| Av. Number of meetings every month | 2.2 | 4.3 | 8.5 | 1.2 | 2.8 | 0.5 |
| Av. Number of users in a given session | 3.2 | 2.2 | 2.3 | 7.5 | 5.5 | 2 |
| Av. Session length (minutes) | 20.2 | 15.7 | 14.2 | 40.1 | 2.5 | 11.1 |
| Av. Number of proposals made per session | 6.5 | 3 | 1.2 | 12 | 11.2 | 0 |
| Av. Number of votes every month | 5.1 | 2.1 | 0.8 | 8.8 | 9 | 0 |
| Av. Purchases per session ($) | 210 | 103 | 0 | 930 | 50 | 13 |
| Av. Number of items purchased per session | 3.2 | 2 | 0 | 10.7 | 6.5 | 2.1 |
| No. of proposal to session length | 0.32 | 0.19 | 0.08 | 0.30 | 4.48 | — |

Taking, for this sample set, the voting pattern for Group 2 (having five shoppers A-E), the following table presents their respective decisions on a series of proposals, and the standard deviation of votes:

TABLE 2

| | Votes polled | | | | | | Tally of votes | | | | | |
|---|---|---|---|---|---|---|---|---|---|---|---|---|
| Topic | Proposer | A | B | C | D | E | 0 | 1 | 2 | 3 | Decision | Std dev |
| Software | A | 0 | 0 | 1 | 1 | 0 | 3 | 2 | 0 | 0 | 0 | 1.50 |
| Software | A | 1 | 1 | 2 | 2 | 1 | 0 | 3 | 2 | 0 | 1 | 1.50 |
| Food | A | 0 | 0 | 1 | 1 | 0 | 3 | 2 | 0 | 0 | 0 | 1.50 |
| Food | A | 0 | 0 | 1 | 1 | 1 | 2 | 3 | 0 | 0 | 1 | 1.50 |
| Food | A | 0 | 0 | 1 | 1 | 1 | 2 | 3 | 0 | 0 | 1 | 1.50 |
| Clothes | A | 0 | 0 | 1 | 1 | 1 | 2 | 3 | 0 | 0 | 1 | 1.50 |
| Movie | A | 1 | 1 | 2 | 3 | 1 | 0 | 3 | 1 | 1 | 1 | 1.26 |
| Music | A | 1 | 1 | 2 | 2 | 1 | 0 | 3 | 2 | 0 | 1 | 1.50 |
| Movie | C | 2 | 2 | 3 | 3 | 2 | 0 | 0 | 3 | 2 | 2 | 1.50 |
| Movie | C | 3 | 0 | 0 | 0 | 0 | 4 | 0 | 0 | 1 | 0 | 1.89 |
| Music | C | 2 | 3 | 3 | 3 | 2 | 0 | 0 | 2 | 3 | 3 | 1.50 |
| Music | C | 0 | 1 | 1 | 1 | 1 | 1 | 4 | 0 | 0 | 1 | 1.89 |
| Movie | C | 1 | 2 | 2 | 2 | 1 | 0 | 2 | 3 | 0 | 2 | 1.50 |
| Food | D | 3 | 0 | 0 | 0 | 0 | 4 | 0 | 0 | 1 | 0 | 1.89 |
| Music | D | 2 | 3 | 3 | 3 | 2 | 0 | 0 | 2 | 3 | 3 | 1.50 |
| Clothes | D | 1 | 1 | 2 | 1 | 1 | 0 | 4 | 1 | 0 | 1 | 1.89 |
| Music | D | 2 | 2 | 3 | 2 | 2 | 0 | 0 | 4 | 1 | 2 | 1.89 |
| Movie | D | 0 | 0 | 1 | 0 | 0 | 4 | 1 | 0 | 0 | 0 | 1.89 |
| Movie | D | 1 | 1 | 2 | 1 | 1 | 0 | 4 | 1 | 0 | 1 | 1.89 |
| Movie | D | 0 | 0 | 1 | 0 | 0 | 4 | 1 | 0 | 0 | 0 | 1.89 |

The frequency distribution of topic proposed for voting by each lead user/proposer is:

TABLE 3

| | Software | Food | Clothes | Music | Movie |
|---|---|---|---|---|---|
| A | 2 | 3 | 1 | 1 | 1 |
| C | 0 | 0 | 0 | 2 | 3 |
| D | 0 | 1 | 1 | 2 | 3 |

In percentage terms, this is:

TABLE 4

| | Software | Food | Clothes | Music | Movie |
|---|---|---|---|---|---|
| A | 25% | 38% | 13% | 13% | 13% |
| C | 0% | 0% | 0% | 40% | 60% |
| D | 0% | 14% | 14% | 29% | 43% |

The discontinuity in topic discussed when the lead user/proposer changes, in percentage terms, this is:

TABLE 5

| | Software | Food | Clothes | Music | Movie | Average |
|---|---|---|---|---|---|---|
| AC | 25% | 23% | 2% | 16% | 30% | 30% |
| AB | 25% | 38% | 13% | 28% | 48% | 19% |
| BC | 0% | 14% | 14% | 11% | 17% | 11% |

The individual purchases during the observation period are:

TABLE 6

| | | | Amount | # |
|---|---|---|---|---|
| User | Date | Product/item | (US $) | items |
| A | July 2001 | Software: Antivirus software | 1200 | 1 |
| A | September 2001 | Fruit Juice: Apple | 20 | 3 |
| A | September 2001 | Cutlery | 50 | 2 |
| A | October 2001 | Vegetables: Spinach | 20 | 2 |
| A | November 2001 | Movie: DVD “New moon” | 10 | 1 |
| A | December 2001 | Movie: DVD “Jurassic Park” | 12 | 1 |
| A | January 2002 | Music: “Madonna New Cd1” | 8 | 1 |
| A | January 2002 | Music: “Madonna New Cd2” | 8 | 1 |
| A | February 2002 | Music: “Michael Jackson New | 9 | 1 |
| | | Cd1” | | |
| B | September 2001 | Van Heusen Trouser, 40 | 15 | 2 |
| B | September 2001 | Arrow Shirt: 42: blue | 12 | 1 |
| B | October 2001 | Movie: DVD “Jurassic Park” | 10 | 1 |
| B | December 2001 | Music: “Madonna New Cd1” | 10 | 1 |
| B | January 2002 | Music: “Madonna New Cd2” | 8 | 1 |
| B | February 2002 | Music: “Michael Jackson New | 9 | 1 |
| | | Cd1” | | |
| C | October 2001 | Music: Christine | 8 | 1 |
| C | October 2001 | Movie: DVD “Machine 2” | 11 | 1 |
| C | November 2001 | Music: Puff Daddy 3 | 7 | 1 |
| C | November 2001 | Movie: DVD “Terminator 1” | 11 | 1 |
| C | December 2001 | Movie: DVD “Terminator 2” | 9 | 1 |
| C | January 2002 | Movie: DVD “New Age | 8 | 1 |
| | | Machine” | | |
| C | January 2002 | Music: James 3 | 10 | 1 |
| D | October 2001 | Fruit Juice: Mango | 20 | 1 |
| D | October 2001 | Clothes: Jeans | 12 | 1 |
| D | November 2001 | Music: “Madonna New | 11 | 1 |
| | | Cd1” | | |
| D | December 2001 | Music: “Madonna New | 12 | 1 |
| | | Cd2” | | |
| D | January 2002 | Movie: DVD “New Age | 10 | 1 |
| | | Machine” | | |
| D | January 2002 | Music: James 3 | 9 | 1 |
| D | February 2002 | Movie: DVD “Terminator 1” | 8 | 1 |
| E | October 2001 | Movie: DVD “Jurassic Park” | 9 | 1 |
| E | October 2001 | Music: “Madonna New Cd1” | 10 | 1 |
| E | November 2001 | Music: “Madonna New Cd2” | 12 | 1 |
| E | December 2001 | Music: “Michael Jackson New | 11 | 1 |
| | | Cd1” | | |
| E | January 2002 | Music: Christine | 12 | 1 |
| E | January 2002 | Movie: DVD “New Age | 10 | 1 |
| | | Machine” | | |
| E | February 2002 | Music: James 3 | 9 | 1 |
| E | April 2002 | Movie: DVD “Terminator 1” | 8 | 1 |

The Group Shopping Cart is:

TABLE 7

| | | | Amount | # |
|---|---|---|---|---|
| User | Date | Product/item | (US $) | items |
| Group2 | October 2001 | Movie: DVD “Classical | 9 | 1 |
| | | Songs” | | |
| Group2 | October 2001 | Music: “Beatles” | 10 | 1 |
| Group2 | November 2001 | Music: “Puff Daddy” | 12 | 1 |
| Group2 | December 2001 | Music: “Michael Jackson | 11 | 1 |
| | | Bad Boys” | | |
| Group2 | January 2002 | Music: Typhoon1 | 12 | 1 |
| Group2 | January 2002 | Movie: DVD “AI” | 10 | 1 |
| Group2 | February 2002 | Music: Britney Spears 3 | 9 | 1 |
| Group2 | April 2002 | Movie: DVD “Ghosts 1” | 8 | 1 |

In the given example for Group 2 shown in Table 5, the discontinuity of topic from shopper A to shopper C is 30%, from shopper A to shopper D is 19% and from shopper C to shopper D is 11%. The average discontinuity for topic between members of the group is 20%. All groups in the sample set can be compared for “harmony” based on this parameter.

When calculated from Table 1, the ratio of number of proposals to session length is highest for Group5 indicating that group's members compete to propose topics and have little time to discuss the proposals.

Referring now to the “melting pot” model of the Group Compatibility and Agreement Index, one example, taken from an examination of the individual purchase history for Group 2 (Table 4) indicates that initially shopper A has interests in software and fruit juices, which gravitate towards music and movies. The same happens for shopper D. Shopper C maintains her interests tending to match the group's interests.

Shopper-Group Interaction Profiling Tool

The Shopper-Group Interaction Profiling Tool 94 profiles the interaction that a shopper has with the groups of which (i) the shopper is member, (ii) is invited to become member of, (iii) the groups that he/she creates, and/or (iv) the groups which he/she was member of in the past. A shopper may be influenced by other shoppers in its buying behavior. A shopper may have some aspirations (likes to compare oneself with), associations (equal), dissociation with individuals (not liked) within the group.

The group behavior can be analyzed to determine if the shopper aspires be like some other individuals in the group or attempts to conform to the group behavior by temporarily changing his/her responses, tends to associate with some and dissociate with some. Some individuals may like to associate with the peer age groups and dissociate from people corresponding to their parent's age. Similarly, each reference individuals can be rated on the degree of influence in the shopper's purchase behavior.

A set of measures is developed, as follows.

Shopper Affinity

Based on the voting record of the shopper, a set of Affinity Indices are created which measure the affinity of the shopper with each other member of the group. The factors contributing to the Affinity Indices are:

1. The number of times the both shoppers A and B have voted together and/or differently. For example, for the Group 2 data given above in Table 2, the affinity between two shoppers is given as the value corresponding to the row and the column of the matrix below. Shoppers A and C have zero affinity. Shoppers A, B and E have strong affinity, while shoppers C and D have strong affinity.

TABLE 8

| | A | B | C | D | E |
|---|---|---|---|---|---|
| A | 20 | 14 | 0 | 5 | 14 |
| B | 14 | 20 | 6 | 11 | 14 |
| C | 0 | 6 | 20 | 14 | 6 |
| D | 5 | 11 | 14 | 20 | 11 |
| E | 14 | 14 | 6 | 11 | 20 |

2. The number of times the shopper A's proposal has been voted YES (and NO) by shopper B. Or the number of times the shopper B's proposal has been voted YES (and NO) by shopper A. For example, for Group 2, the affinity between two members is given the value corresponding to the row and the column of the matrix below. Shopper B has agreed with shopper A and shopper D every time he/she has proposed a topic for vote. Shopper D has agreed every time shopper C has suggested some topic for vote. Shopper E shows very little inclination of voting along with the lead proposer.

TABLE 9

| Proposer | A | B | C | D | E |
|---|---|---|---|---|---|
| A | 8 | 8 | 0 | 0 | 5 |
| B | 0 | 0 | 0 | 0 | 0 |
| C | 0 | 4 | 5 | 5 | 2 |
| D | 5 | 7 | 2 | 7 | 6 |
| E | 0 | 0 | 0 | 0 | 0 |

3. The number of times shopper A has invited shopper B.

4. The number of times shopper B has invited shopper A.

5. The number of groups in which shopper A and shopper B are together (and are not together).

If there are N shoppers, then for every shopper i, there are (N-1) affinity indices, one each for the remaining shoppers. The affinity index can be represented as A_{i,j} which represents the affinity of shopper i for shopper j.

Leadership

Based on the voting and the shopping record (purchases made) of the shopper, (conveniently referred as shopper A) a set of Leadership Indices are created which measure the leadership role played by the shopper. The event “purchase” can be replaced by any other event of merchant's interest. The merchant may specify the events for profiling using the Merchant Parameter Specification Tool 60. The factors contributing to the Leadership Indices are:

1. The number of times A's proposals/suggestions have been followed by other shoppers in his/her purchases (or other events of merchant's interest). It is clear from the example of Group2, that despite making the maximum number of proposals, shopper A has changed his shopping behavior to follow the group. In the given example for Group 2 shown in Table 6, Shopper A purchased variety of products cutlery, software, vegetables until November 2001. However, after October 2001, the group shopping cart and purchases reflect interests in Music and Movies. The same is reflected in individual purchases made by Shopper A after November 2001. Shopper C and shopper D have emerged as leaders in Group 2 as they have influenced the group behavior. As shown in Table 4, most of the proposals of Shoppers C and Shoppers D were for movies and music.

2. The number of times shopper A's proposals/suggestions have received positive response from the group (obtained through voting records). Five out of eight proposals made by shopper A, four out of five proposals by shopper C and seven out of seven proposals made by shopper D have been accepted. (The choice of the lead user is also the decision made by the group). Shopper D has the highest proportion of the proposals accepted. Shoppers B and E have not made any proposal. They are clearly not the leaders in the group.

3. The margin of positive to negative votes polled on proposals/suggestions made by shopper A. Shopper A lost the three votes by a margin of 3:2, shopper C lost one vote by margin of 3:2 and shopper D has not lost a single vote.

4. The percentage of discussion threads initiated by A and the length of the ensuing discussion.

5. The extent of a shopper's participation in the overall discussions.

The shopper has many personalities within itself. The actual self reflects how the individual actually is, although the shopper may not be aware of that reality. In contrast, the ideal self reflects a self that a person would like to have, but does not in fact have. For example, a person with no physical training may want to be a world famous athlete, but may have no actual athletic ability. The private self is one that is not intentionally exposed to others. For example, a teenager may like and listen to a classical music in private, but project a public self-image of being a rock music enthusiast. Group behavior in the collaborative shopping setting enables the merchant to understand the distinct user behavior when he/she shops individually and when as a group. The hidden private self and projected image can be gathered from purchases and click stream data of the shopper. In fact, a merchant may make recommendations which might help individuals augment their public image.

Conformity

Based on the voting and the shopping record (purchases made) of the shopper, (conveniently referred as shopper A) a set of Conformity Indices are created which measure the desire of the shopper to conform to the group behavior. The event “purchase” can be replaced by any other event of merchant's interest. The merchant may specify the events for profiling using the Merchant Parameter Specification Tool 60. The factors contributing to the Conformity Indices are:

1. The number of times shopper A has changed his/her vote depending on the previous votes made by shopper B. Based on trend analysis of the voting record of both shopper A and shopper B, if shopper A had a conflicting vote with shopper B and in a later vote, shopper A changes his/her vote to conform to shopper B's vote (as suggested by previous voting pattern of shopper B).

2. The number of times shopper A has voted in a certain manner and acted in an opposite manner in a private session soon after a voting. The action may include one of the events of merchant interest.

3. The number of times shopper A has voted along with the lead user and the number of times shopper A has voted along with the majority. For example, in Group2, shopper B has not proposed any topic for voting and agrees mostly with the lead user. Both shopper B and shopper E vote along with the majority.

The voting pattern for Group 2 is:

TABLE 10

| | A | B | C | D | E |
|---|---|---|---|---|---|
| Votes along with the lead | 41.7% | 95.0% | 13.3% | 38.5% | 65.0% |
| user | | | | | |
| Votes along with the | 55.0% | 85.0% | 45.0% | 70.0% | 85.0% |
| majority | | | | | |

Assertiveness

Based on the voting and the shopping record (purchases made) of the shopper, (conveniently referred to as shopper A) a set of Assertiveness Indices are created which measure the assertiveness of the shopper. The event “purchase” can be replaced by any other event of merchant's interest. The merchant may specify the events for profiling using the Merchant Parameter Specification Tool 60. The factors contributing to the Assertiveness Indices are:

1. The number of times A has voted against a particular object specified in the proposals within a short period of time.

2. The number of times A has voted against an another member of the shopper to ask him/her to leave the group.

Targeting Tool

Based on the measure determined at least for the shopper's group-interaction profile, but perhaps also the individual shopper's profile, the group profile, and of the groups of which the shopper is member, the targeting tool 58 enables an outside agent to:
(i) define rules on these measures,
(ii) determine rules based on specific purchase or shopper behavior on the site of the merchant, or
(iii) enable the merchant to enter a model for targeting shoppers using these profile measures by coupling the profile with a learning algorithm from the Learning Algorithm Repository 62.

An outside agent may select a learning algorithm from the repository 62 and make a selection from the list of shopper measures which shall be used by the learning algorithm, or the learning algorithm might itself make use of any existing feature selection mechanism to select the relevant features which may be used the learning algorithm to predict the probability of purchase or any other shopper activity of the merchant's interest.

Adaptive Learning Based on Promotions

The targeting tool 58 learns from the response of shoppers to different promotions based on some of the customer features as stored in the Library of User Profiles 54 and the features of the promotions. The learning algorithms act as a prediction tool which can be used to determine whether a promotion should be shown to a customer, which promotions should be shown to a particular customer, or to whom a particular promotion should be shown.

A supervised learning algorithm (for example, decision trees, neural network), which uses the response of shoppers with different characteristics and tries to learn the mapping from shopper attributes (individual, group or shopper-group interaction profile) and the response to promotions of a particular nature, can identify the lucrative segments to target.

The shopper profile contains the shopper information, behavior of the shopper in different groups and the shopper-group interaction profile. For example, how does a customer A respond to a promotion when she is shopping with another customer B, who is shown the same or may be a different promotion.

The learning algorithms generate rules, which can take the following form:

(a) Segment of shoppers “A” should be shown promotions of a specific nature. For example, all shoppers who are member of 5 groups, actively participate in at least 2 groups, are dominant member in one and follow leadership of another shopper in another group (as defined in the shopper-group interaction profiling discussed above), should be shown promotions which highlight the self-confidence of the shopper.

(b) Segment of shoppers “B” should be shown a promotion X at the time when they are shopping along with shoppers of segment “C”, who shall be shown a promotion Y at the same time. In this specific case, the shopper-group interaction profile contains the information about which shopper shops along with another shopper and how does he/she responds to promotions at that point in time. The shoppers of segment “C” may exhibit higher scores on one or more leadership indices and shoppers of segment “B” may exhibit higher scores on a group affinity index and a conformity index.

(c) Segment of shoppers “A” (higher scores on leadership index and assertiveness index) should be shown a promotion X, followed by promotion Y being shown to their followers (shoppers with lower scores on assertiveness and higher scores on affinity index). For example, shoppers who are leaders in some groups, but are new to another group, should see a promotion earlier than other members, enabling them to establish their leadership in the group. The members of their new groups will see the same promotion after a time lag.

(d) Segment of shoppers “A” should be shown a promotion X, while the leader of their respective groups should be shown a promotion Y. For example, shoppers who do not conform to group shopping behavior should be shown a different promotion than shown to the leader of their groups.

(e) Segment of shoppers “A” (for example, with higher scores on assertiveness index) should be shown an advertisement immediately after the collaborative shopping session is over. For example, shoppers who retain their individuality in collaborative shopping situations (lower affinity scores) need to assert themselves when they start acting as individuals. The best time to target may be immediately after the collaborative shopping session is over, as they may be more in need of re-asserting their individuality.

(f) Segment of shoppers “A” is shown a promotion, if A makes a purchase, it is also shown to the shopper “B”. For example, B has strong affinity for A. When A sees a promotion and makes a purchase, it is very likely B would also purchase the product. The more general rule will specify whether the promotion should be shown to B immediately after A's purchase, or after a time lag.

The above rules are only some examples of nature of targeting rules that can be discovered. Also, at the same time, the learning algorithms need not necessarily generate rules. It may suffice to give the probability of purchase of a particular product by a customer at a given point in time.

The rules are stored in the Targeting Knowledge Repository 66, which can be re-used to rate customers and promotions on the propensity of the customer to respond to a specific promotion.

While the learning algorithms can determine segment specific rules using one or more of the shopper-group interaction measures, broad targeting strategy can be determined by using a shopper's group shopping behavior. For example, following measures have specific influence in the targeting strategy to be used:

1. If the culture of the group of which the shopper is a member is best described by the “melting pot” model, then one should run integrated promotions aimed at all individuals. For the “salad bowl” model groups, each individual should be approached separately.

2. Weighted correlation analysis of group profile items 1 and 2 with individual profile. Each attribute can be weighted by the individual's participation in the group and the average can be correlated with the group profile. High correlation characterizes the group as a salad bowl; low correlation characterizes the group as a melting pot.

Shopping Context

Besides capturing shopper group profile and shopper-group interaction profile, the group shopping behavior also contains substantial information about the group shopping context. To capture this group shopping context, specific attributes are defined which can be used in the adaptive learning to determine targeting rules and strategies. Some of these specific shopping context attributes are:
(a) Shopping with another shopper (parameter: identity of the shopper, identity of the other shopper),
(b) Shopping after another shopper (parameters: identity of the shopper, time elapsed after another shopper has shopped, identity of the other shopper),
(c) Shopper A is shown promotion X after shopper B is shown promotion Y. (parameter: identity of the shopper, identity of the other shopper, identity of the promotion (for example X), identity of the other promotion (for example Y), time difference between two promotions being shown), and
(d) Shopper A is shown promotion X while shopper B is shown promotion Y. (parameter: identity of the shopper, identity of the other shopper, identity of the promotion (for example X), identity of the other promotion (for example Y)),

Different targeting rules can be learnt, based on different shopping contexts. For example, segment of shoppers “B” should be shown a promotion X at the time when they are shopping along with shoppers of segment “C”, who shall be shown a promotion Y at the same time. In this specific case, the shopper-group interaction profile contains the information about the shopping context and how does he/she responds to promotions at that point in time. The shoppers of segment “C” may exhibit higher scores on leadership indices and shoppers of segment “B” may exhibit higher scores on group affinity index and conformity index.

Library of Promotions

The Library of Promotions 64 contains advertisements, coupons, discounts, surveys, opinion polls, or any other promotions that a merchant or group of merchants may want to run. The promotions may be characterized by the product, the category to which they belong, the behavioral attribute or benefit they highlight, and the customer's target segment. This information about the promotions may be provided by the merchant or any other outside agent. The Library 64 also stores the response of each user to the promotion shown to him/her. This contains information like what time the promotion was shown to which customer and what was the response of the customer. It contains a reference to the promotion (from the Promotions Library 64) and the user (the Library of User Profiles 54).

Targeting Knowledge Repository

The Targeting Knowledge Repository 66 stores the learned model from the learning algorithm, which can be applied to a set of promotions and customers to determine the propensity of each customer to respond to each specific promotion. In specific cases, the propensity may be a number between 0 to 1, or simply either 0 or 1.

Learning Algorithm Repository

The Learning Algorithm Repository 62 may comprise or make use of a neural network, reinforcement learning algorithm, kernel based MAP classifier, MAP classifier, Nearest Neighbor classifier, Voronoi diagram based classification of shopper's, Bayes classifier, bagging or boosting algorithm, genetic algorithm, simulated annealing algorithm, or any other combination of these algorithms or algorithms derived from these basic algorithms.

Computer Hardware and Software

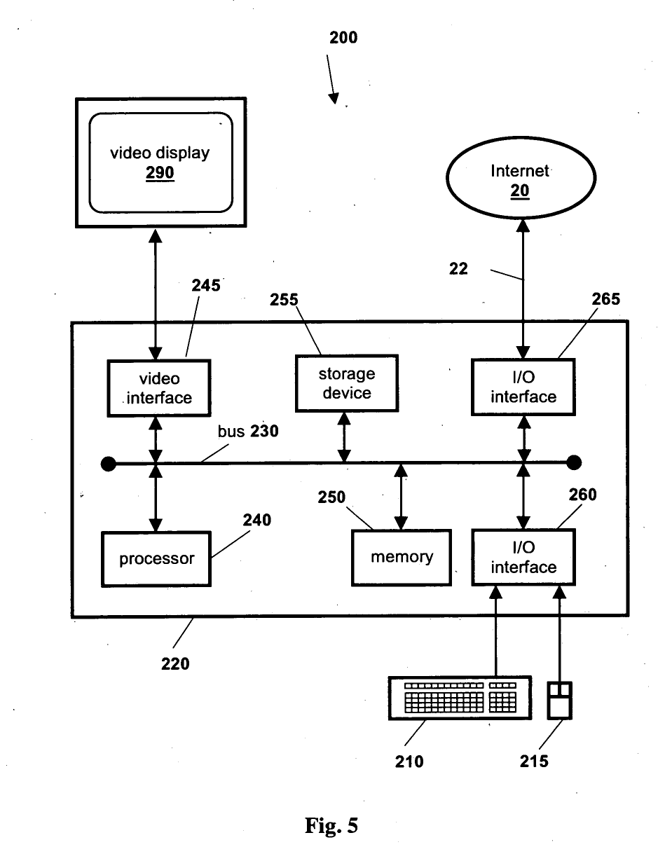

FIG. 5 is a suitable operating system installed on a computer system 200 to assist in performing the described techniques of the hosting server 24. This computer software is programmed using any suitable computer programming language, and may be thought of as comprising various software code means for achieving particular steps.

The components of the computer system 200 include a computer 220, a keyboard 210 and mouse 215, and a video display 290. The computer 220 includes a processor 240, a memory 250, input/output (I/O) interfaces 260, 265, a video interface 245, and a storage device 255.

The processor 240 is a central processing unit (CPU) that executes the operating system and the computer software executing under the operating system. The memory 250 includes random access memory (RAM) and read-only memory (ROM), and is used under direction of the processor 240.

The video interface 245 is connected to video display 290 and provides video signals for display on the video display 290. User input to operate the computer 220 is provided from the keyboard 210 and mouse 215. The storage device 255 can include a disk drive or any other suitable storage medium.

Each of the components of the computer 220 is connected to an internal bus 230 that includes data, address, and control buses, to allow components of the computer 220 to communicate with each other via the bus 230.

The computer system 200 can be connected to one or more other similar computers via a input/output (I/O) interface 265 using the communication channel 22 to a network, represented as the Internet 20.

The computer software may be recorded on a portable storage medium, in which case, the computer software program is accessed by the computer system 200 from the storage device 255. Alternatively, the computer software can be accessed directly from the Internet 280 by the computer 220. In either case, a user can interact with the computer system 200 using the keyboard 210 and mouse 215 to operate the programmed computer software executing on the computer 220.

Other configurations or types of computer systems can be equally well used to implement the described techniques. The computer system 200 described above is described only as an example of a particular type of system suitable for implementing the described techniques.

### Conclusion

Embodiments of the invention have application in electronic commerce and server computers for performing such transactions. Various alterations and modifications can be made to the techniques and arrangements described herein, as would be apparent to one skilled in the relevant art.

1-42. (canceled)

43. A method for targeting shoppers participating in online shopping with at least one merchant, said method comprising the steps of:
collecting data regarding choices of individual shoppers when shopping individually;
collecting data regarding the choices of individual shoppers when participating in group shopping;
determining a shopper-group interaction measure from individual shopper data and group shopper data;
determining targeted information on a basis of said shopper-group interaction measure; and
sending said targeted information to one or more targeted shoppers.

44. The method of claim 43, wherein said shopper-group interaction measure is determined based on any of:
a shopper affinity index,
a leadership index,
a conformity index, and
an assertiveness index.

45. The method of claim 44, wherein said shopper affinity index is determined from a number of times a shopper has voted with other members of a group of shoppers.

46. The method of claim 44, wherein said shopper affinity index is determined from a number of times a shopper's proposal has been voted for by other members of a group of shoppers.

47. The method of claim 44, wherein said shopper affinity index is determined from a number of times a shopper has been invited by, or issued an invitation to other members of a group of shoppers.

48. The method of claim 44, wherein said shopper affinity index is determined from a number of shopping groups that a shopper is a commonly member of with other shoppers.

49. The method of claim 44, wherein said leadership index is determined from records of purchaser recommendations of said shopper and a number of times other shoppers in a group of shoppers have followed such a recommendation.

50. The method of claim 44, wherein said conformity index is determined from a voting record of said shopper regarding purchase proposals with reference to agreeing with a majority or lead shopper's vote within a group of shoppers.

51. The method of claim 44, wherein said assertiveness index is determined from a voting record of said shopper regarding purchase proposal with reference to disagreeing with a majority of lead shopper's vote within a group of shoppers.

52. The method of claim 44, wherein said indices are a function of a shopper parameter specified by said merchant.

53. The method of claim 43, wherein said targeted information is determined by any of:
a rule specified by said merchant, and
an adaptive algorithmic rule.

54. The method of claim 53, wherein said rule specified by said merchant and said adaptive algorithmic rule further determine which are to be said targeted shoppers.

55. The method of claim 53, wherein said rule specified by said merchant is based on a particular promotion of goods or services by said merchant.

56. The method of claim 53, wherein said adaptive algorithmic rule learns from any of:
a shopper affinity index,
a leadership index,
a conformity index, and
an assertiveness index,
and wherein the indices are determined from said shopper-group interaction measure.

57. The method of claim 56, wherein said adaptive algorithmic rule further learns from said shopper-group interaction measure to decide whether to target information to a group or to individual shoppers.

58. A method for targeting shoppers participating in online shopping with at least one merchant, said method comprising the steps of:
collecting data regarding choices of individual shoppers when shopping individually;
determining an individual shopping behavior measure from the individual shopper data;
collecting data regarding the choices of individual shoppers when participating in group shopping;
determining a group shopping behavior measure from the group shopping data;
determining a shopper-group interaction measure from said individual shopper data and said group shopper data;
determining targeted information based on said individual shopping behavior measure, said group shopping behavior measure, and said shopper-group interaction measure; and
sending said targeted information to one or more targeted shoppers.

59. The method of claim 58, wherein said targeted information is determined by any of:
a rule specified by said merchant, and
an adaptive algorithmic rule.

60. The method of claim 59, wherein said rule specified by said merchant and said adaptive algorithmic rule further determine which are to be said targeted shoppers.

61. The method of claim 59, wherein said rule specified by said merchant is based on a particular promotion of goods or services by a said merchant.

62. The method of claim 59, wherein said adaptive algorithmic rule learns from any of:
a shopper affinity index,
a leadership index,
a conformity index, and
an assertiveness index,
and wherein said indices are determined from said shopper-group interaction measure.

63. The method of claim 59, wherein said adaptive algorithmic rule further learns from said shopper-group interaction measure to decide whether to target information to a group or to individual shoppers.

64. The method of claim 63, wherein said group shopping measure is determined by any of:
a group compatibility and agreement index,
a maturity index,
a group youthfulness index, and
a group harmony index.

65. The method of claim 64, wherein said group compatibility and agreement index is calculated based on a time series of group shopping history and said individual shopping behavior measure to give an indication of either assimilation leading to targeting information to a group, or lack of assimilation leading to targeting information to individual shoppers.

66. The method of claim 65, wherein said individual shopping behavior measure comprises information on demographics, income, purchase history, navigation history, and preferences.

67. The method of claim 59, wherein said adaptive algorithmic rule further learns from a shopping context measure derived from the individual shopper data.

68. An online shopping system comprising:
a plurality of shopper terminals;
at least one merchant site; and
a shopping server system connected to said shopper terminals and said merchant sites by a communications link, and wherein said server system includes:
an input/output interface;
a memory unit operable for collecting and storing data via said input/output interface regarding choices of individual shoppers when shopping individually, and data regarding choices of individual shoppers when participating in group shopping;
a processor operable for determining a shopper-group interaction measure from the individual shopper data and the group shopper data, and determining targeting information based on of said shopper group interaction measure; and
wherein said input/output interface sends said targeted information to one or more targeted shoppers.

69. An online shopping server for interacting with a plurality of shoppers and at least one merchant, comprising:
an input/output interface;
a memory unit operable for collecting and storing data via said input/output interface regarding choices of individual shoppers when shopping individually, and data regarding the choices of individual shoppers when participating in group shopping;
a processor operable for determining a shopper-group interaction measure from the individual shopper data and the group shopper data, and determines targeting information on the basis of said shopper group interaction measure;
and wherein said input/output interface sends said targeted information to one or more targeted shoppers.

70. The server of claim 69, wherein said processor is operable for determining said shopper-group interaction measure based on any of:
a shopper affinity index,
a leadership index,
a conformity index, and
an assertiveness index.

71. The server of claim 70, wherein said processor is operable for determining affinity index from a number of times a shopper has voted with other members of a group of shoppers.

72. The server of claim 70, wherein said processor is operable for determining shopper affinity index from a number of times a shopper's proposal has been voted for by other members of a group of shoppers.

73. The server of claim 70, wherein said processor is operable for determining said shopper affinity index from a number of times a shopper has been invited by, or issued an invitation to other members of a group of shoppers.

74. The server of claim 70, wherein said processor is operable for determining said shopper affinity index from a number of shopping groups that a shopper is a commonly member of with other shoppers.

75. The server of claim 70, wherein said processor is operable for determining said leadership index from records of purchaser recommendations of a shopper and a number of times other shoppers in a group of shoppers have followed such a recommendation.

76. The server of claim 70, wherein said processor is operable for determining said conformity index from a voting record of a shopper regarding purchase proposals with reference to agreeing with a majority or lead shopper's vote within a group of shoppers.

77. The server of claim 70, wherein said processor is operable for determining said assertiveness index from a voting record of a shopper regarding purchase proposal with reference to disagreeing with a majority of lead shopper's vote within a group of shoppers.

78. The server of claim 70, wherein the indices are determined by said processor as a function of a shopper parameter specified by a merchant input via said input/output interface.

79. The server of claim 69, wherein said processor is operable for determining said targeted information based on any of:
a rule specified by a merchant input via said input/output interface, and
an adaptive algorithmic rule stored in said memory unit.

80. The server of claim 79, wherein said processor is operable for determining which are to be said targeted shoppers based on a merchant rule and said adaptive algorithmic rule.

81. The server of claim 79, wherein said merchant rule is based on a particular promotion of goods or services by said merchant.

82. The server of claim 79, wherein said adaptive algorithmic rule learns from any of:
a shopper affinity index,
a leadership index,
a conformity index, and
an assertiveness index,
and wherein the indices are determined by said processor from said shopper-group interaction measure.

83. The server of claim 80, wherein said processor applying said adaptive algorithmic rule further learns from the group shopping measure to decide whether to target information to a group or to individual shoppers.

84. A program storage device readable by computer, tangibly embodying a program of instructions executable by the computer to perform a method for targeting shoppers participating in online shopping with at least one merchant, said method comprising:
collecting data regarding choices of individual shoppers when shopping individually;
collecting data regarding choices of individual shoppers when participating in group shopping;
determining a shopper-group interaction measure from the individual shopper data and said group shopper data;
determining targeted information based on said shopper-group interaction measure; and
sending said targeted information to one or more targeted shoppers.
